(19) United States
(12) Patent Application Publication
(10) Pub. No.: US 2012/0101689 A1
(43) Pub. Date: Apr. 26, 2012

(54) METHOD FOR OPERATING A MOTOR VEHICLE AND MOTOR VEHICLE

(75) Inventor: Thomas SCHRAMM, Mainz (DE)

(73) Assignee: GM GLOBAL TECHNOLOGY OPERATIONS LLC, Detroit, MI (US)

(21) Appl. No.: 13/278,272

(22) Filed: Oct. 21, 2011

(30) Foreign Application Priority Data
Oct. 21, 2010 (DE) 102010049081.4

(51) Int. Cl. G06F 19/00; G05D 3/00

(52) U.S. Cl. 701/45; 701/36; 701/49

(57) ABSTRACT

A method is provided for operating a motor vehicle. The method includes, but is not limited to determining whether at least one control is activated by a driver of the motor vehicle while driving the motor vehicle. The at least one control is here part of an onboard system, selected from the group comprised of an information and entertainment system, an air conditioner, a mirror adjuster, a seat adjuster, a navigation system, a first driver assistance system and/or a telephone system. In addition, at least one parameter of a second driver assistance system of the motor vehicle is adjusted if the at least one control is activated by the driver of the motor vehicle while driving the motor vehicle.

### CROSS-REFERENCE TO RELATED APPLICATION

This application claims priority to German Patent Application No. 102010049081.4, filed Oct. 21, 2010, which is incorporated herein by reference in its entirety.

### TECHNICAL FIELD

The technical field relates to a method for operating a motor vehicle, a motor vehicle, a computer program product and a computer-readable medium.

### BACKGROUND

Known from DE 10 2008 042 342 A1 is a method for assessing the attentiveness of the driver of a vehicle, which encompasses the step of acquiring a plurality of sensor values by way of an interface, wherein the sensor values represent steering information and/or gas pedal information and/or the speed of the vehicle. The method further encompasses a step of determining assessment values from the plurality of sensor values according to prescribed assessment instructions. In addition, the method encompasses a step of comparing the assessment values with threshold values and providing comparison values that depend on the comparison, and a step of assessing the attentiveness of the driver based on the comparison values.

At least one object is to indicate a method for operating a motor vehicle, a motor vehicle, a computer program product and a computer-readable medium that allow an enhanced driving safety. In addition, other objects, desirable features and characteristics will become apparent from the subsequent summary and detailed description, and the appended claims, taken in conjunction with the accompanying drawings and this background.

### SUMMARY

A method is provided for operating a motor vehicle exhibits the following steps. A determination is made whether at least one control is activated by a driver of the motor vehicle while driving the motor vehicle. The at least one control is here part of an onboard system, selected from the group comprised of an information and entertainment system, an air conditioner, a mirror adjuster, a seat adjuster, a navigation system, a first driver assistance system and/or a telephone system. In addition, at least one parameter of at least one second driver assistance system of the motor vehicle that differs from the first driver assistance system is adjusted if the at least one control is activated by the driver of the motor vehicle while driving the motor vehicle.

Understood here and below by a driver assistance system is an electronic device in the motor vehicle that is designed to assist the driver in certain driving situations. The assistance can here in particular entail taking a partially or completely autonomous action involving the transmission, controller or signaling equipment of the motor vehicle, or issuing a warning message.

By determining whether the at least one control is activated by the driver of the motor vehicle while driving the motor vehicle, the method for operating the motor vehicle according to the application makes it possible to infer when a driver might experience a future, longer-term distraction or divert his or her eyes from the road while driving. The information about the future, typically longer-term driver distraction makes it possible to adjust the second driver assistance system or several driver assistance systems to this changed driving situation. This advantageously results in a higher level of driving safety.

An embodiment also involves determining how long the at least one control is activated, and adjusting the at least one parameter if the driver of the motor vehicle activates the at least one control for a predetermined period of time while driving the motor vehicle. Additionally or alternatively, how frequently the at least one control is activated, i.e., an activation frequency, can be determined, and the at least one parameter is adjusted if the frequency with which the driver of the motor vehicle activates the at least one control while driving the motor vehicle exceeds a predetermined threshold value. The two mentioned embodiments advantageously make it possible to determine to an even greater extent how distracted the driver is with respect to the duration of the distraction, and to base the adjustment of the at least one parameter on an ascertained longer-term driver distraction. For example, the at least one control is designed as a control key, a control knob or a touch-sensitive display device.

In one embodiment of the method, the second driver assistance system is designed to issue a warning message. Adjusting the at least one parameter of the second driver assistance system here involves adjusting a threshold for issuing the warning message so as to issue the warning message at an earlier point in time.

The second driver assistance system is here preferably selected from the group consisting of a lane departure warning system and a collision warning system. The mentioned embodiments advantageously make it possible to shift the time of the warning message toward “early”, giving the driver a longer timeframe in which to react. Additionally or alternatively, the second driver assistance system can be designed for automatically activating a brake and/or drive and/or steering unit of the vehicle. In this embodiment, adjusting the at least one parameter of the second driver assistance system involves adjusting a threshold value for automatic activation in such a way that the automatic activation takes place at an earlier point in time.

The second driver assistance system is here preferably selected from the group consisting of an emergency brake system, a brake assistant and a lane departure warning system. The mentioned embodiments advantageously make it possible to use the information about the future, typically longer-term driver distraction to adjust the second driver assistance system so that it intervenes earlier in motor vehicle operation. In addition, the second driver assistance system can be designed as an adaptive cruise control system. In this embodiment, adjusting the at least one parameter involves increasing the following distance from a vehicle in front that has been selected as the target vehicle for the adaptive cruise control system. Therefore, the second driver assistance system in the form of the adaptive cruise control system uses the information about the future distraction of the driver to advantageously select a longer safety distance.

Whether the at least one control is activated by the driver of the motor vehicle while driving the motor vehicle can be determined with data from at least one seat occupancy sensor, in particular with data from a seat occupancy sensor of a passenger seat in the motor vehicle, and/or with data from at least one optical camera, which in particular records a front region of a passenger cabin of the motor vehicle, and/or with a position of the at least one control within the motor vehicle, and/or with data from a fingerprint sensor.

For example, if the at least one control is activated, data from the at least one seat occupancy sensor can be used to determine whether a passenger seat of the motor vehicle is occupied by a passenger. If it is determined in the process that the passenger seat is not occupied, it can thereby be concluded that the at least one control has been activated by the driver of the motor vehicle. In addition, the driver seat and passenger seat can each be equipped with a coupling electrode, for example which is formed by a seat heating unit. The coupling electrodes can be supplied with signals of varying frequency, e.g., approximately 20 kHz and approximately 25 kHz. In this embodiment, the at least one control exhibits a sensor surface that, when the control is activated, is conductively touched by the activating person or separated by a dielectric, thereby establishing a capacitive coupling with the respective person upon activation. Based on the varying frequencies, an evaluator can determine whether the control inputs were made by the driver or passenger.

In addition, for example, the position of the at least one control within the motor vehicle can be used to infer that it has been activated by the driver if the at least one control is situated within reach of the driver, i.e., in a region typically only used by the driver of the motor vehicle, in particular on the steering wheel of the motor vehicle.

In addition, data from the fingerprint sensor can be used to arrive at a corresponding determination, for example if the startup of the motor vehicle is approved or initiated by data from the fingerprint sensor, thereby making the corresponding data for the driver available. Further, data from a speed sensor in the motor vehicle can be used to determine whether it is moving or not. As a result, it can be determined whether the at least one control is activated while the car is being driven.

In another embodiment, the at least one parameter of the second driver assistance system is adjusted in such a way as to adjust a value for the at least one parameter as a function of the system containing the at least one control. This makes it possible to advantageously weight or classify the level of driver distraction as a function of the onboard system being operated by the driver. For example, operating the navigation system can distract the driver of the vehicle from road traffic to more of an extent than operating the seat adjuster. Correspondingly, the at least one parameter in the first case can be adjusted so as to modify a threshold for issuing a warning message in such a way that the warning message is issued at an earlier point in time than in the second case, automatic activation takes place at an earlier point in time than in the second case and/or the following distance is lengthened by comparison to the second case.

In another embodiment, it is additionally determined whether the driver of the motor vehicle has stopped operating the onboard system. The at least one parameter of the second driver assistance system is here reset to the value preceding the adjustment if it is determined that the driver of the motor vehicle has stopped operating the onboard system.

In another embodiment of the method, the at least one parameter is reset to the value preceding the adjustment after a predetermined time has elapsed since the at least one parameter of the second driver assistance system was adjusted. Therefore, the driver assistance system in the embodiments mentioned can advantageously be returned to the originally set or prescribed operating state after the period of elevated driver distraction has ended.

In addition, the application relates to a motor vehicle that exhibits a determination device. The determination device is designed to ascertain whether at least one control is activated by a driver of the motor vehicle while driving the motor vehicle. The at least one control is here part of an onboard system, selected from the group comprised of an information and entertainment system, an air conditioner, a mirror adjuster, a seat adjuster, a navigation system, a first driver assistance system and/or a telephone system. In addition, the motor vehicle exhibits at least a second driver assistance system that differs from the first driver assistance system. Further, the motor vehicle exhibits an adjustment device, wherein the adjustment device is designed to adjust at least one parameter of the second driver assistance system if the at least one control is activated by the driver of the motor vehicle while driving the motor vehicle. For example, the motor vehicle is a passenger car or truck.

The motor vehicle exhibits the advantages already mentioned in conjunction with the method according to the application, which will at this juncture not be listed again to avoid repetition.

In another embodiment, the second driver assistance system is designed to issue a warning message. The adjustment device is here designed to adjust a threshold of the second driver assistance system to issue the warning message in such a way as to issue the warning message at an earlier point in time. Further, the second driver assistance system can additionally or alternatively be designed to automatically activate a brake and/or drive and/or steering unit of the motor vehicle. The adjustment device is here designed to adjust a threshold value of the second driver assistance system for automatic activation in such a way that automatic activation takes place at an earlier point in time. In another embodiment, the second driver assistance system is designed as an adaptive cruise control system. In this embodiment, the adjustment device is designed to increase the following distance from a vehicle in front that has been selected as the target vehicle for the adaptive cruise control system.

A computer program product is also provided that, when loaded on a central processing unit of a motor vehicle, directs the central processing unit to perform the following steps. The central processing unit is directed to ascertain whether at least one control is activated by a driver of the motor vehicle while driving the motor vehicle. The at least one control is here part of an onboard system, selected from the group comprised of an information and entertainment system, an air conditioner, a mirror adjuster, a seat adjuster, a navigation system, a first driver assistance system and/or a telephone system. In addition, the central processing unit is directed to adjust at least one parameter of at least one second driver assistance system of the motor vehicle that differs from the first driver assistance system if the at least one control is activated by the driver of the motor vehicle while driving the motor vehicle.

In addition, the application relates to a computer-readable medium, which stores a computer program product according to the mentioned embodiment. The computer program product and computer-readable medium according to the application exhibit the advantages already mentioned in conjunction with the method according to the application, which will at this juncture not be listed again to avoid repetition.

### BRIEF DESCRIPTION OF THE DRAWINGS

The present invention will hereinafter be described in conjunction with the following drawing figures, wherein like numerals denote like elements, and:

FIG. 1 shows a flowchart of a method for operating a motor vehicle according to an embodiment;

FIG. 2 shows a motor vehicle with an onboard system according to an embodiment; and

FIG. 3 shows the onboard system of the motor vehicle according to FIG. 2.

### DETAILED DESCRIPTION

The following detailed description is merely exemplary in nature and is not intended to limit application and uses. Furthermore, there is no intention to be bound by any theory presented in the preceding background or summary or the following detailed description.

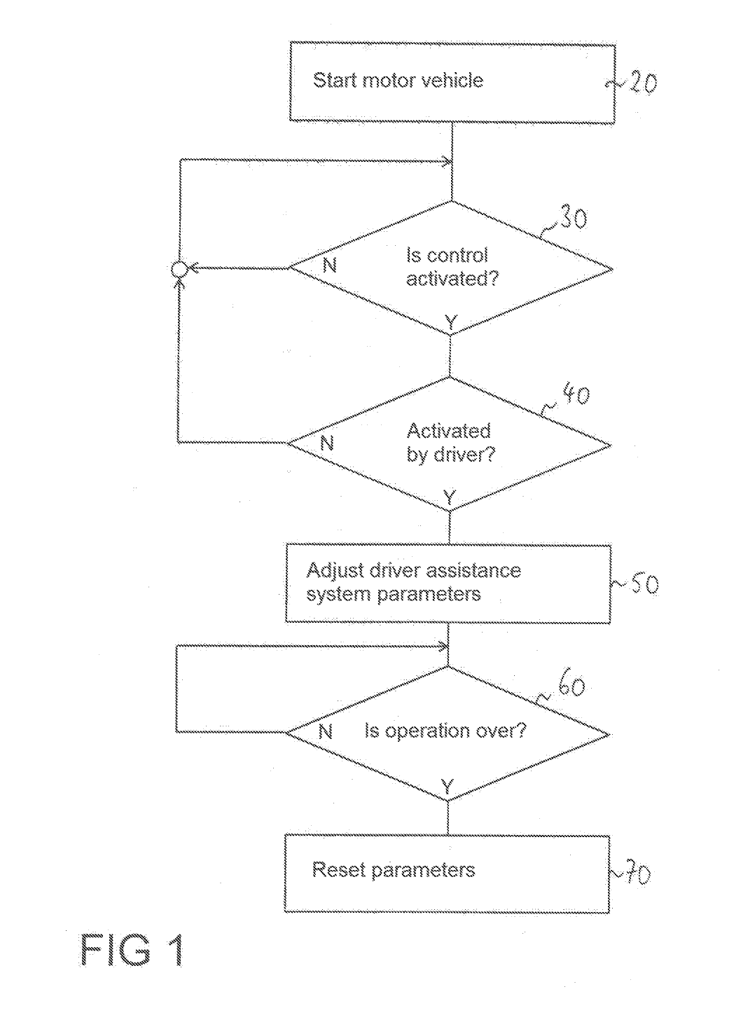

FIG. 1 shows a flowchart of a method for operating a motor vehicle according to an embodiment. The motor vehicle is here typically a passenger car or truck. The motor vehicle is started up in a step 20. After the motor vehicle has been started up, meaning while the motor vehicle is in operation, it is determined in step 30 whether at least one control of an onboard system is activated, typically while the motor vehicle is being driven. The onboard system is here selected from the group comprised of an information and entertainment system, for example a radio system of the motor vehicle, an air conditioner, a mirror adjuster, a seat adjuster, a navigation system, a first driver assistance system and/or a telephone system.

If it is determined that the at least one control is not activated, step 30 is repeated. By contrast, if it is determined that the at least one control is activated, step 40 is performed to ascertain whether the control is being activated by a driver of the motor vehicle. For example, this can take place using data from at least one seat occupancy sensor, and/or using data from at least one optical camera and/or using a position of the at least one control within the motor vehicle. If it is determined in step 40 that the activation is not performed by the driver of the motor vehicle, but rather by the passenger of the motor vehicle, for example, step 30 is repeated, along with step 40, if needed.

By contrast, if it is determined that the at least one control is activated by the driver of the motor vehicle, meaning if it is found that the driver will experience a future, longer-term distraction or divert his or her eyes from the road while driving, at least one parameter of at least one second driver assistance system of the motor vehicle is adjusted in step 50.

In another embodiment, step 30 here also involves determining how long the at least one control is activated and/or how frequently the at least one control is activated. The at least one parameter is here adjusted in step 50, if the at least one control is activated for a predetermined duration by the driver of the motor vehicle, or if the frequency with which the at least one control is activated by the driver of the motor vehicle exceeds a predetermined threshold.

Whether or not the driver has stopped operating the onboard system is subsequently determined in step 60. For example, it is determined whether any additional input is being made, in particular any further activation of the at least one control. If it is here determined that the driver has not yet stopped operating the system, step 60 is repeated.

By contrast, it if is determined that the driver of the motor vehicle has stopped operating the onboard system, the at least one parameter of the at least one second driver assistance system is reset to the value preceding the adjustment in step 70. In an alternative embodiment, the at least one parameter is reset to the value preceding the adjustment after a prescribed period of time has elapsed since the parameter was adjusted.

Therefore, the mentioned embodiment can be used to advantageously draw conclusions about a future and longer-term driver distraction or driver diversion based on operator inputs by the driver in onboard systems. As a result, the mentioned embodiment describes a method for predicting a driver distraction. A longer-term distraction of the driver can here be inferred when drivers perform operations on specific keys or actuators of onboard systems, or call up specific menus associated with onboard systems, such as the navigation system or telephone system.

For example, if a telephone call is answered or a telephone number is dialed, the driver can be classified as distracted for the duration of the conversation. The same holds true when entering a destination in a navigation system, for example. For example, as soon as the “input destination” menu item is selected, it can be assumed that the driver is just about to experience a longer-term distraction. It is typically regarded as over once the destination has been input, but at most after a defined length of time.

Information about a future, typically longer-term distraction can prompt various driver assistance systems, for example a lane departure warning system and/or a collision warning system, to warn the driver at an earlier point in time. The corresponding warning messages are here also referred to as so-called “lane departure warning” or “forward collision alert”. Further, various driver assistance systems can intervene earlier with this information, for example the lane departure warning system once again and/or the emergency brake system. The interventions mentioned first are here also referred to as so-called “lane centering” or “lane keeping”. In addition, a larger safety distance can be selected if the driver assistance system is designed as an adaptive cruise control system, which is also referred to as ACC (adaptive cruise control).

In particular, the threshold values of the driver assistance systems set using the information about a future, typically longer-term driver distraction can be modified, for example the distance when following another vehicle. This results in a higher level of driving safety. In like manner, the time of the driver warnings can be shifted toward “early”, giving the driver a longer timeframe in which to react. This also results in a higher level of driver safety.

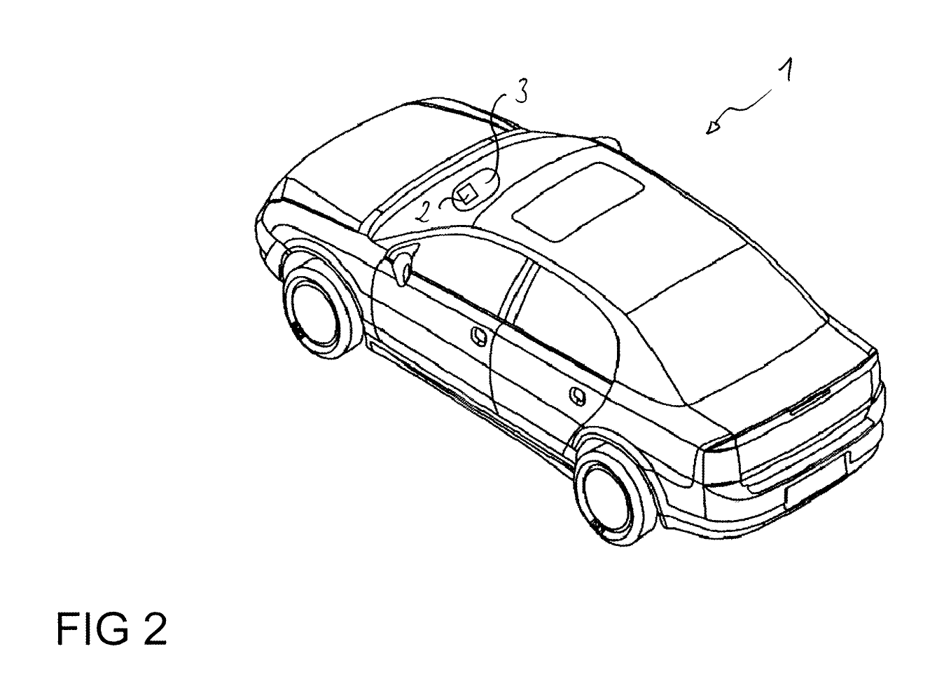

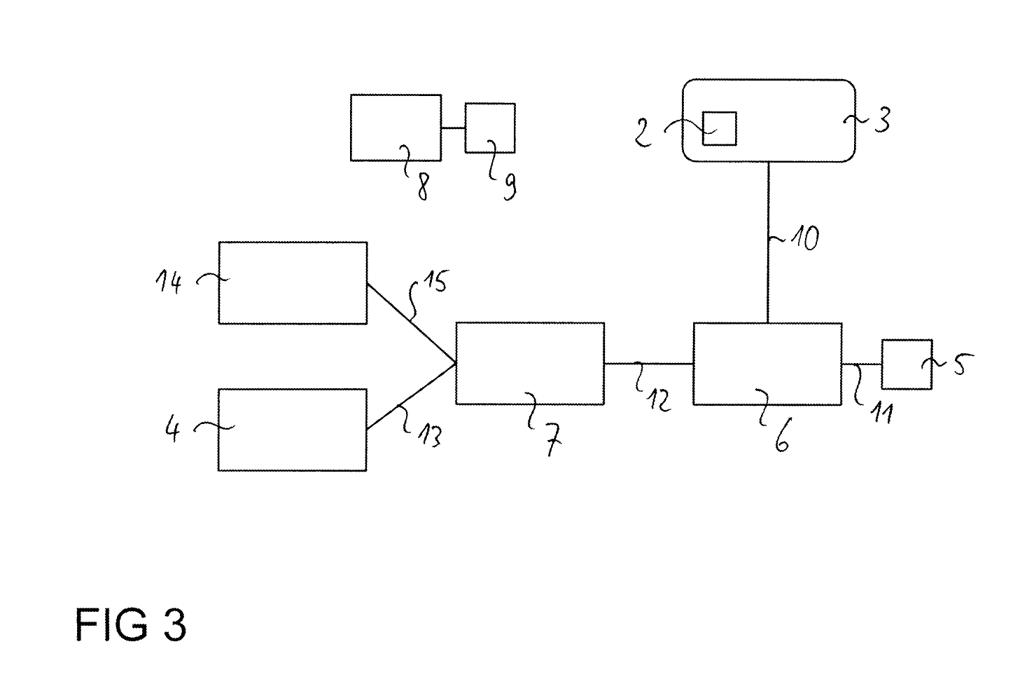

FIG. 2 shows a motor vehicle 1 with an onboard system 3 according to an embodiment of the application. The motor vehicle 1 is a passenger car in the embodiment depicted. For example, the onboard system 3 can be an information and entertainment system, an air conditioner, a navigation system, a first driver assistance system or a telephone system of motor vehicle 1, and exhibits a control 2, for examples a control key, a control knob or a touch-sensitive display. Additional details will be explained in conjunction with the following FIG. 3. To this end, FIG. 3 shows the onboard system 3 of the motor vehicle according to FIG. 2.

The onboard system 3 is linked with a determination device 6 of the motor vehicle via a connecting cable 10. The determination device 6 is designed to ascertain whether the control 2 is being activated by a driver of the motor vehicle while driving the motor vehicle. To this end, the determination device 6 in the embodiment depicted is connected via a signal line 11 with a seat occupancy sensor 5, typically a seat occupancy sensor of a passenger seat of the motor vehicle (not shown). Therefore, data from the seat occupancy sensor 5 can be used to determine whether the control 2 is being activated by the driver of the motor vehicle.

Further, the motor vehicle not shown in any greater detail on FIG. 3 exhibits a second driver assistance system 4 along with a third driver assistance system 14. For example, the second driver assistance system 4 is a lane departure warning system or a collision warning system of the motor vehicle, and the third driver assistance system 14 is an emergency brake system, a brake assistant or an adaptive cruise control system of the motor vehicle.

The motor vehicle further exhibits an adjustment device 7. The adjustment device 7 is designed to adjust at least one parameter of the second driver assistance system 4 and at least one parameter of the third driver assistance system 14 if the control 2 is activated by the driver of the motor vehicle while driving the motor vehicle. To this end, the adjustment device 7 is linked with the determination device 6 via a connecting cable 12, as well as with the second driver assistance system 4 via a connecting cable 13, and with the third driver assistance system 14 via a connecting cable 15.

The motor vehicle further exhibits a central processing unit 8 and a computer-readable medium 9, wherein the computer-readable medium 9 stores a computer program product that, when loaded on the central processing unit 8, directs the central processing unit 8 to perform the mentioned steps of the method according to the application, in particular the embodiment depicted on FIG. 1, using the elements mentioned therein. To this end, the central processing unit 8 is directly or indirectly linked with the mentioned components in a manner not shown in any greater detail.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for operating a motor vehicle, comprising:
determining whether at least one control is activated by a driver of the motor vehicle while driving the motor vehicle,
wherein the at least one control is part of an onboard system; and
adjusting at least one parameter of a driver assistance system of the motor vehicle if the at least one control is activated by the driver of the motor vehicle while driving the motor vehicle.

2. The method according to claim 1, wherein the onboard system is an information and entertainment system

3. The method according to claim 1, further comprising:
issuing a warning message with the driver assistance system, and
wherein the adjusting the at least one parameter of the driver assistance system comprises adjusting a threshold for issuing the warning message.

4. The method according to claim 3, wherein the driver assistance system is a lane departure warning system.

5. The method according to claim 3, wherein the driver assistance system is a collision warning system.

6. The method according to claim 1, further comprising:
automatically activating a control unit of the motor vehicle with the driver assistance system, and
wherein the adjusting the at least one parameter of the driver assistance system involves adjusting a threshold value for the automatically activating the control unit.

7. The method according to claim 6, wherein the control unit is a brake unit.

8. The method according to claim 1, wherein the driver assistance system is a lane departure warning system.

9. The method according to claim 1,
wherein the driver assistance system is an adaptive cruise control system, and
wherein adjusting the at least one parameter involves increasing a distance from a vehicle in front that has been selected as a target vehicle for the adaptive cruise control system.

10. The method according to claim 1,
wherein whether the at least one control is activated by the driver of the motor vehicle while driving the motor vehicle is determined with data from at least one seat occupancy sensor.

11. The method according to claim 1, further comprising:
determining whether the driver of the motor vehicle has ceased operating the onboard system, and
wherein the at least one parameter of the driver assistance system is reset to a value preceding the adjusting if the driver of the motor vehicle has ceased operating the onboard system.

12. The method according to claim 1, wherein the at least one parameter is reset to a value preceding the adjusting after a predetermined time has elapsed since the adjusting the at least one parameter of the driver assistance system.

13. A motor vehicle, comprising:
a determination device configured to determine whether at least one control is activated by a driver of the motor vehicle while driving the motor vehicle, wherein the at least one control is part of an onboard system;
a driver assistance system;
an adjustment device configured to adapt at least one parameter of the driver assistance system of the motor vehicle if the at least one control is activated by the driver of the motor vehicle while driving the motor vehicle.

14. The motor vehicle according to claim 13, wherein the onboard system is a seat adjuster.

15. The motor vehicle according to claim 13, wherein the onboard system is a navigation system.

16. The motor vehicle according to claim 13, wherein the onboard system is a second driver assistance system.

17. The motor vehicle according to claim 13,
wherein the driver assistance system is configured to issue a warning message, and
wherein the adjustment device is configured to adjust a threshold value of the driver assistance system to issue the warning message in such a way that the warning message is issued at an earlier point in time.

18. The motor vehicle according to claim 13,
wherein the driver assistance system is configured to automatically activate a control unit of the motor vehicle, and
wherein the adjustment device is configured to adjust a threshold value of the driver assistance system for automatic activation in such a way that automatic activation takes place at an earlier point in time.

19. The motor vehicle according to claim 13,
wherein the driver assistance system is designed as an adaptive cruise control system, and
wherein the adjustment device is configured to increase a following distance from a vehicle in front that has been selected as a target vehicle for the adaptive cruise control system.

20. A computer readable medium embodying a computer program product, said computer program product comprising:
an operating program for operating a motor vehicle, the operating program configured to:
determine whether at least one control is activated by a driver of the motor vehicle while driving the motor vehicle,
wherein the at least one control is part of an onboard system; and
adjust at least one parameter of a driver assistance system of the motor vehicle if the at least one control is activated by the driver of the motor vehicle while driving the motor vehicle.
